(19) United States
(12) Patent Application Publication
(10) Pub. No.: US 2010/0109603 A1
(43) Pub. Date: May 6, 2010

(54) Battery alternating recharging process

(76) Inventor: Michael Steven Hargett, Salem, OR (US)

Correspondence Address: Michael S. HARGETT, 5116 NORMA CT. S.E., SALEM, OR, 97306, US

(21) Appl. No.: 12/290,740

(22) Filed: Oct. 31, 2008

(51) Int. Cl. H02J 7/00; H02K 53/00

(52) U.S. Cl. 320/109; 415/916

(57) ABSTRACT

As an example in this Patent Application which focuses on the need to have a battery system last longer in all battery applications in various devices. These devices are cell phones, generators of electricity and actually too many other types of devices which are too numerous to mention. Using the electric vehicle in this Application which is one of the best examples. Using the electric vehicle, which in the past has not been a practical means of transporting people as well as goods, due to the recharging of the Batteries. The most important negative reason is the length of time the Batteries could supply electric current in the operation of the vehicle. The batteries in an electric vehicle have kept this mode of transportation from becoming cost efficient. The recharging of the batteries in an electric vehicle has taken a required amount of time to recharge. The time required has meant the electric vehicle could not be used. The time required to recharge the batteries has been the major reason for not advancing the electric vehicle's use in a practical, everyday means. The batteries' limited time of supplying electric current for use has been a contributing factor limiting the distance that is needed in everyday modern modes of travel. This invention uses the Battery Alternating Recharging Process, which allows the time and distance to be attained in which these negatives can be overcome, eliminating the need to have the electric vehicle to be taken out of service to be charged.

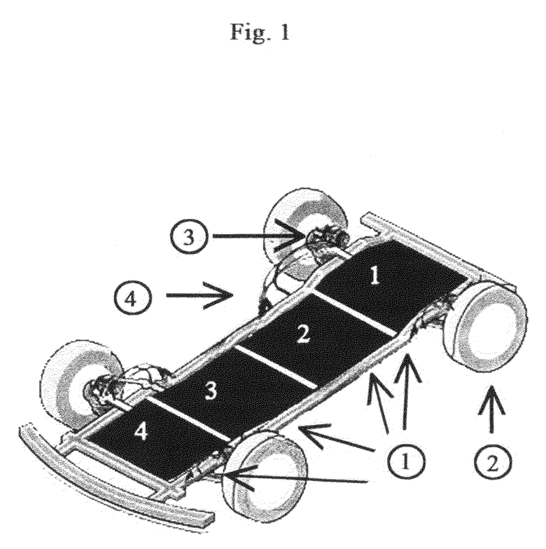

### SUMMARY

This invention consists of the means to allow all types of devices to operate at greater lengths of service using batteries. Using the example of a Battery Operated Electric Vehicle. This invention will allow the Battery Operated Electric Vehicle to travel at distances, which will make it cost efficient and practical for everyday use. This invention will allow people to use the electric vehicle as never before, due to the great distances it can travel in transporting people and goods. The invention will also allow the means to transport goods and people to destinations that normally would require great sums of fossil fuels. These fossil fuels are harmful to the environment in various ways. A few ways to mention are the air, water and the impact on the world climate change. The climate is changing from what is termed Green House Gases. The result is long-term, irreversible global warming. This invention incorporates the alternating use of the batteries in powering of the electric vehicle. This alternating the battery use and the recharging of the batteries once they are used in the operation or driving of the electric vehicle, then charging them as they are depleted by and on board or an attachment of an electricity-producing device. This device comes in many forms that would be suitable for this application. These devices will supply the proper electric current needed to fulfill the battery charging in the Battery Alternating Recharging Process.

### DESCRIPTION OF PRIOR ART AND CROSS REFERENCE APPLICATIONS AND PATENTS

There is no prior art to report.

There are no other patents to report in the patent search. There were 0 results of any additional patents in the search.

### FIELD OF INVENTION

This invention relates to: 1) The need to have electronic or any electric-powered device provide greater lengths of service, increasing the time of use. The example is the electric vehicle, which could be made to travel farther distances than ever before. 2) This invention also addresses and shortens the length of time required to recharge the batteries in an electric vehicle. 3) This invention addresses the need to have an environmentally safer form of travel. 4) This invention decreases the need on foreign fossil fuels, which helps the United States become less dependent on those nations that are considered to be unfriendly and, in some cases, an adversary to our global policy and national security.

### DESCRIPTION OF THE DRAWING, PAGE 1

FIG. (1) As the example used herein, the electric vehicle shows a simplified overhead view of the electric vehicle chassis looking down from above. This downward overhead view is without the exterior vehicle body cover, seats, steering wheel, electric motor, transmission and other electric vehicle parts that are standard in an electric vehicle. This simplified view is to eliminate all other components so the focus can be directed entirely on the Battery Alternating Recharging Process with its components in the electric vehicle only. FIG. (1) shows only the basic components which are required in the function of the Battery Alternating Recharging Process for the electric vehicle.

Number 1 in FIG. (1) shows the four battery packs in the electric vehicle. These four battery packs are the battery packs that are used in the Battery Alternating Recharging Process. Four battery packs are used in number 1 of FIG. (1) only for the description of this drawing. It must b e noted that the number of batteries is determined by the electric vehicle's design in attaining distance and time traveled. The number of batteries can be as many as two, or as many as needed in any desired application.

Number 2 in FIG. (1) shows a vehicle standard tire and wheel of an electric vehicle. This type of tire and wheel are the same as any fossil fuel vehicle being driven today.

Number 3 in FIG. (1) shows an electricity-producing device. In this drawing it is an alternator. This alternator is one of sufficient output of electricity to power the Battery Alternating Recharging Process for the electric vehicle in the drawing FIG. (1). There are many types of electricity-producing devices available that could be applied to the Battery Alternating Recharging Process; to name one more, a gasoline powered generator. It is not necessary to name others in this application. Any device that produces the sufficient

### DESCRIPTION OF THE DRAWING, PAGE 2

amounts of electricity can be used. The electricity producing device in this application generates electricity when the wheel of the electric vehicle turns. The wheel turns when it is being driven. In FIG. (1), these electricity-producing devices are dedicated to each of the four wheels; these wheels are shown as number 2 in FIG. (1).

Number 4 in FIG. (1) shows the simple wiring that is required to operate the Battery Alternating Recharging Process. This is a simple wiring example of positive, negative and ground wires that are attached to the electricity producing device that is number 3 in FIG. (1). These electric wires run from the electricity producing device to the positive, negative and ground terminals of the batteries.

### PREFERRED EMBODIMENT, PAGE 1

The example device used herein, which is the electric vehicle, has for many years proven to be a costly means of travel. It is certain that a means of extending the life of an electric vehicle's batteries would make the electric vehicle more efficient as a means of travel than a fossil fuel-powered vehicle. The cost reduction of transporting people and goods would drop dramatically with the Battery Alternating Recharging Process. As you can see in the drawing of the electric vehicle, FIG. (1) #1 shows the use of four batteries. These batteries can be clumped together in packs. Whether individually or in packs, they are used by alternating their use; the amount of batteries or packs used is determined by the requirements of a particular vehicle's operation. In the operation of the process, the batteries that are depleted enter a recharging phase, the others that are depleted are simultaneously recharged in the Battery Alternating Recharging Process, then bringing them back online when charged to be reused in powering the electric vehicle. Meeting these needs in extending the electric vehicle's time and distance, it can be made to travel great distances.

### PREFERRED EMBODIMENT, PAGE 2

The Battery Alternating Recharging Process works as a means to extend the batteries' usage time in their many uses. In this example, an electric vehicle's travel time. This invention's example (which is the electric vehicle) would allow it to travel greater distances. The process works this way: taking an electric vehicle and equipping the vehicle with four battery packs, which are in the Description of the Drawing. The four battery packs that are used in the invention are for description only; there can be as many as two or as many as desired to achieve a certain distance or time of travel.

By using multiple battery packs, you can extend the time and distance traveled by the electric vehicle, or other battery powered devices.

In the drawing FIG. (1) #1: there are four battery sections in this drawing for this application. There can be as many batteries as needed to allow the process to recycle itself in the discharge and recharge of the Battery Alternating Recharging Process. FIG (1) #2 is standard automotive wheel and rubber tire. FIG. (1) #3 shows the electricity producing devices that are attached to the electric vehicle's wheels. These devices in the drawing are alternators specifically for this patent application. The alternator supplies the electric current that is needed to operate the Battery Alternating Recharging Process. However, the devices may be of other types, such as gasoline, biodiesel, propane, hydrogen, solar generators and other powering fuels that produce electric current. FIG. (1) #4 shows the electric wires that supply or carry the electric current from the alternators to the batteries. These wires carry the electric current to supply the depleted batteries once they have been discharged of their electricity. These same wires supply or carry the electric current that is needed for the Battery Alternating Recharging Process to be successful.

### PREFERRED EMBODIMENT, PAGE 3

The Battery Alternating Recharging Process will create the desired time and distance that an electric vehicle can travel by using this invention.

This is how the process works in the electric vehicle; however, it works the same for other devices and applications to achieve extended battery use.

You start off by using the #1 battery pack. While the vehicle is being driven by the #1 battery pack, the electric vehicle will sense when #1 battery pack starts to be depleted. When the electric vehicle senses #l's depletion, then the #2 battery pack comes online to be used the power the electric vehicle. As #2 battery pack is used, the #1 battery pack goes into the recharging phase of the process. As #2 begins to be depleted, the electric vehicle senses the depletion of #2, and #3 battery pack comes online to be used. As #3 battery pack is being depleted, the electric vehicle senses that depletion and #4 battery pack comes online to be used. #3 battery pack enters the recharging phase. When #4 battery pack is depleted, the electric vehicle senses the depletion of #4 and switches back to #1 battery pack, which is now charged and ready to power the electric vehicle. When #1 comes online to power the electric vehicle, #4 enters the recharging process and the Battery Alternating Recharging Process starts over. The process repeats itself over and over.

1. Claim 1 is the use of two or more batteries or battery packs in the Battery Alternating Recharging Process. The process starts with one battery or battery pack. When number 1 battery or pack is depleted, number 2 battery or pack comes into use. When number 2 battery or pack is depleted, number 3 battery or pack comes into use. When number 3 battery or pack is depleted, number 4 battery or pack comes into use. When number 4 battery or pack is depleted, after completing the recharging phase of the batteries or packs, the number 1 battery or pack returns to service. As the batteries or packs are depleted, they enter a recharging phase, powered by an onboard charger. Thus the description, Battery Alternating Recharging Process.

2. Claim 2 is the alternating use of the batteries or battery packs for the purpose of recharging an electric vehicle's batteries while in motion or while being driven; in essence, while in operation. The electric vehicle does not have to be stopped or parked and connected to a power source for the means of recharging the batteries. The process is completed by an onboard charging system. This process will allow the freedom from the power connection to charge the electric vehicle.

3. Claim 3 is the broad use of the Battery Alternating Recharging Process described in this patent application. For an example, airplanes, helicopters, military vehicles of all types (such as a Humvee). The Humvee would become a mobile power station that would supply electric power for all needs in the field of operations, such as war zones, and emergency vehicles driven to disaster areas.
Other examples are all types of seagoing vessels, military, passenger, freight vehicles. Other examples are freight and passenger trains. To give further examples of the many uses of the Battery Alternating Recharging Process: apartment complexes or a housing development such as a subdivision. The process would work as supplying power to the homes and apartments with a central power station supplying the power to operate the Battery Alternating Recharging Process in which the homes and apartments are equipped. One last example: a hiker or military person would use the process as a nano power source in a backpack for electric power. This application would power all the individuals' electric power needs; camping, or in the hostile field of operations, in desolate places, war zones. Claim 3, in essence: the Battery Alternating Recharging Process can supply electric power for all electric power needs in any environment.
